(19) United States
(12) Patent Application Publication
(10) Pub. No.: US 2025/0176086 A1
(43) Pub. Date: May 29, 2025

(54) MULTI-MODAL PROGRAMMABLE SOUND-RESPONSIVE LIGHTING UNIT AND APPLICATION

(71) Applicant: Varsity Music, Inc., Toledo, OH (US)

(72) Inventors: Jacob Schmieder, Toledo, OH (US); Jack Evans, Ames, IA (US); Logan TeKolste, Stuart, IA (US); Samantha Lavin, Madison, WI (US); Nathaniel T. Paskach, Pella, IA (US)

(21) Appl. No.: 19/039,634

(22) Filed: Jan. 28, 2025

Related U.S. Application Data
(63) Continuation-in-part of application No. 18/926,474, filed on Oct. 25, 2024.
(60) Provisional application No. 63/581,028, filed on Sep. 7, 2023.

(51) Int. Cl. H05B 47/12; G06F 3/16; G10H 1/00; H05B 45/20; H05B 47/17

(52) U.S. Cl. CPC H05B 47/12; G06F 3/162; G10H 1/0008; H05B 45/20; H05B 47/17; G10H 2210/066; G10H 2220/021

(57) ABSTRACT

A lighting device for a musical instrument includes an LED configured to attach to the musical instrument, a microphone, a communication interface configured to communicate with a mobile device, and a controller. The controller is selectable between a plurality of operating modes including at least one tone-responsive mode and at least one performance mode. In the tone-responsive mode, the controller receives an ambient audio signal from the microphone, detects a tone of the musical instrument based on the ambient audio signal, and dynamically controls a lighting characteristic output by the LED based on the detected tone. In the performance mode, the controller wirelessly receives a set cuing signal from the communication interface for changing between a predefined group of sets, and controls the LED during each of the predefined group of sets according to respective preprogrammed lighting patterns for each of the predefined group of sets.

### CROSS-REFERENCE TO RELATED APPLICATIONS

This application is a continuation-in-part of U.S. application Ser. No. 18/926,474 filed on Oct. 25, 2024, which claims the benefit of U.S. Provisional Patent Application No. 63/581,028 filed on Sep. 7, 2023, which are each hereby incorporated by reference in their entirety.

### BACKGROUND

Marching bands may serve as entertainment at sporting events, parades, carnivals, rallies, or as standalone performances. In addition to musical performances, marching bands may create various visual elements through different formations, coordinated movements, and/or electronically-assisted visual effects.

### SUMMARY

According to an aspect of the present disclosure, a lighting device for a musical instrument includes an LED configured to attach to a musical instrument, a microphone, a communication interface configured to communicate with a mobile device, and a controller operatively coupled to the LED, the microphone, and the communication interface. The controller is selectable between a plurality of operating modes including at least one tone-responsive mode and at least one performance mode. In the at least one tone-responsive mode, the controller operates to receive an ambient audio signal from the microphone, detect a tone of the musical instrument based on the ambient audio signal, and dynamically control a lighting characteristic output by the LED based on the detected tone. In the at least one performance mode, the controller operates to wirelessly receive a set cuing signal from the communication interface for changing between a predefined group of sets, and control the LED during each of the predefined group of sets according to respective preprogrammed lighting patterns for each of the predefined group of sets.

The at least one tone-responsive mode may include a tuning mode. When operating in the tuning mode, the controller may be configured to compare a detected pitch from the ambient audio signal against a reference pitch and control the LED to output a color indicative of whether the detected pitch is sharp, flat, or in tune relative to the reference pitch. The controller may be configured to receive, via the communication interface, user-defined color settings associating specific colors with sharp, flat, and in-tune pitch states, and the controller may control the LED according to the user-defined color settings. In one implementation of the tuning mode, the controller samples audio via the microphone to obtain sampled audio, determines a frequency and amplitude of the sampled audio, compares the amplitude to a minimum threshold, detects a closest musical note if the amplitude exceeds the minimum threshold, determines a deviation between the frequency and the musical note, maps the deviation to an LED color based on a predefined mapping, and sets the LED to output the LED color.

The tone-responsive mode may also include a game mode. When operating in the game mode, the controller may be configured to compare detected musical tones from the ambient audio signal to a predefined musical score and control the LED to output lighting patterns indicative of accuracy of the detected musical tones relative to the predefined musical score.

The tone-responsive mode may furthermore include a tone color mode in which the controller controls an LED color that maps to a detected musical note. In one implementation of the tone color mode, the controller samples audio via the microphone to obtain sampled audio, determines a frequency and an amplitude of the sampled audio, compares the amplitude to a predefined minimum threshold, determines a closest musical tone from the sampled audio if the amplitude exceeds the predefined minimum threshold, maps the musical tone to a color based on a predefined mapping, and sets the LED to output the mapped color. The controller may be configurable to receive, via the communication interface, the predefined mapping from a user interface of a mobile device that obtains user-defined color mappings.

According to another aspect of the present disclosure, a method of operating a lighting device attachable to a musical instrument is provided. The method includes configuring a controller of the lighting device in a tone-responsive mode. While operating in the tone-responsive mode, the lighting device receives, by a microphone of the lighting device, an ambient audio signal, detects a tone of the ambient audio signal; and dynamically controls a lighting characteristic of an LED of the lighting device based on the detected tone. The lighting device may be reconfigured to operate in performance mode. While operating in the performance mode, the lighting device receives, by a communication interface of the lighting device, a wireless set cuing signal, changes, by the controller, between a predefined group of sets based on the received set cuing signal, and controls, by the controller, the LED during each of the predefined group of sets according to respective preprogrammed lighting patterns for each of the predefined group of sets.

According to another aspect of the present disclosure, a system includes a lighting device for a musical instrument. The lighting device comprises: an LED, a microphone, a communication interface configured to communicate with a mobile device, and a controller operatively coupled to the LED, the microphone, and the communication interface. The controller may be selectable between a plurality of operating modes. In at least one such operating mode, the controller may operate to receive an ambient audio signal from the microphone, detect a musical tone of the musical instrument based on the ambient audio signal, and dynamically control a lighting characteristic output by the LED based on the detected musical tone. In at least a second operating mode, the controller may operate to wirelessly receive a set cuing signal from the communication interface for changing between a predefined group of sets, and control the LED during each of the predefined group of sets according to respective preprogrammed lighting patterns for each of the predefined group of sets. A non-transitory computer-readable storage medium of a mobile device stores instructions that, when executed by a processor of the mobile device, cause the mobile device to perform steps including establishing a wireless connection with the lighting device via the communication interface, transmitting control information to the lighting device including at least one color mapping applied by the lighting device in the tone-responsive mode that maps the detected tone to the lighting characteristic, and transmitting set information to the lighting device including the predefined group of sets for the at least one performance mode.

### BRIEF DESCRIPTION OF FIGURES

FIG. 1 illustrates a computing environment for facilitating operation of programmable lighting units, according to aspects of the present disclosure.

FIG. 2 is an example embodiment of a lighting unit, according to an embodiment.

FIG. 3 illustrates a block diagram of a lighting unit, according to aspects of the present disclosure.

FIG. 4 illustrates various examples of lighting units attached to musical instruments, according to an embodiment.

FIG. 5 is a flowchart illustrating a process for operating a lighting unit for a musical instrument, according to an embodiment.

FIG. 6 is a flowchart illustrating a process for mode switching in a lighting unit with a single control button, according to aspects of the present disclosure.

FIG. 7 is a flowchart illustrating a process for operating a lighting unit in a tone color mode, according to aspects of the present disclosure.

FIG. 8 illustrates a tone color mode user interface screen for configuring settings for a tone color mode of a lighting unit, according to aspects of the present disclosure.

FIG. 9 is a flowchart illustrating a process for operating a lighting unit in a tuning mode, according to aspects of the present disclosure.

FIG. 10 illustrates a tuning mode user interface screen for configuring settings for a tuning mode of a lighting unit, according to aspects of the present disclosure.

FIG. 11 is a flowchart illustrating a process for operating a lighting unit in a performance mode, according to aspects of the present disclosure.

FIG. 12 illustrates a first performance mode user interface screen of a mobile application for managing show files, according to aspects of the present disclosure.

FIG. 13 illustrates a second performance mode user interface screen of a mobile application for managing show files, according to aspects of the present disclosure.

FIG. 14 illustrates a connection screen for a mobile application, according to aspects of the present disclosure.

FIG. 15 illustrates a settings screen of a mobile device user interface for associating a lighting unit with a musical instrument, according to aspects of the present disclosure.

FIG. 16 illustrates a settings screen showing an instrument selection interface of a mobile application, according to aspects of the present disclosure.

FIG. 17 is a flowchart illustrating a process for operating a lighting unit in a gaming mode, according to aspects of the present disclosure.

FIG. 18 is an example of a desktop application user interface for configuring a set of lighting units in association with a performance, according to aspects of the present disclosure.

FIG. 19 is a flowchart illustrating an example embodiment of a process performed by a management application.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. Wherever practicable, similar or like reference numbers may be used in the figures and may indicate similar or like functionality.

A multi-modal programmable sound-responsive lighting system includes a lighting unit to facilitate various lighting functions associated with practices and performances by a marching band, ensemble, individual musicians, or other musical performer. Each lighting unit may be designed to attach to a musical instrument and/or to an individual performer and may produce various lighting effects according to programmable timing and/or color settings. A fleet of lighting units may be programmed to operate in a coordinated manner during a performance by a marching band or other performance.

The lighting units may operate according to multiple operation modes. The operating modes may include at least one tone-responsive mode and at least one performance mode. The tone-responsive mode may enable the lighting units to operate according to colors and/or timing patterns that are based at least in part on detected audio tones. Such modes may be used to facilitate tuning functions, to automate displayed color patterns in coordination with a musical score being performed, or to respond to accuracy of a performance relative to a predefined musical score. The performance mode may enable the lighting system to be programmable to display pre-programmed lighting patterns across a set of lighting units associated with respective members of a musical performance group (such as marching band) during a performance. The lighting patterns may change dynamically for different sets of the performance in response to a wireless cuing signal received by the lighting unit.

The lighting system may operate in conjunction with one or more management applications that facilitate creation of a performance including preprogrammed lighting patterns.

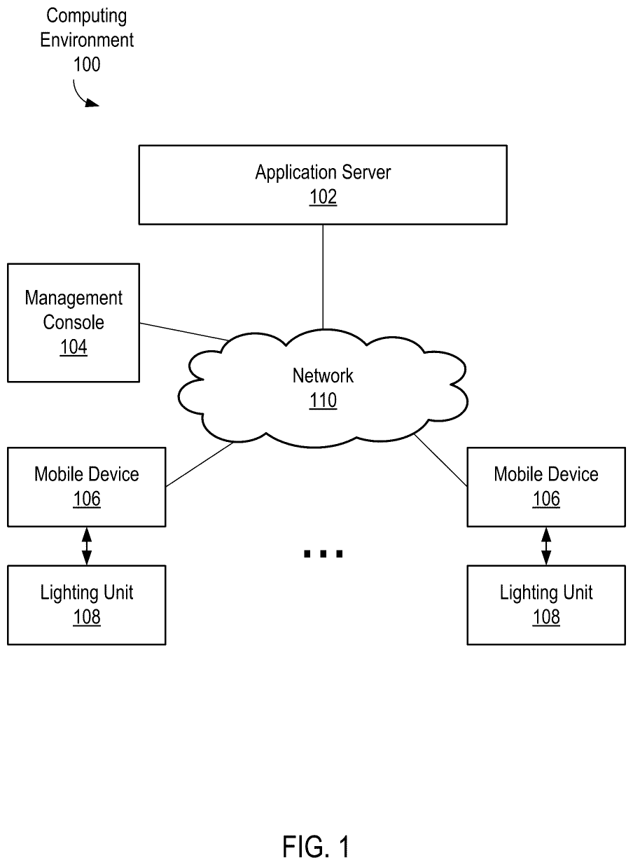

FIG. 1 illustrates a computing environment 100 for facilitating operation of a set of multi-modal programmable sound-responsive lighting units. The computing environment 100 may include an application server 102, a management console 104, one or more mobile devices 106, and one or more lighting units 108, coupled by a network 110.

The application server 102 may comprise one or more computing devices for supporting operations of the management console 104 and mobile devices 106. In some cases, the application server 102 may store performance files associated with preprogrammed performances and may store profile information pertaining to users and groups. The application server 102 may furthermore host a web application accessible by the management console 104 and/or a file server for downloading a management application and/or mobile applications associated with operations of the lighting system.

The management console 104 may facilitate execution of a management application for managing various aspects of the set of lighting units 108 and associated mobile devices 106. In some cases, the management console 104 may comprise a desktop or laptop computer. In other cases, the management console 104 may comprise any computing device such as a mobile phone, tablet, gaming console, head mounted display (HMD), or other computing device.

The management console 104 may provide various user interface tools to enable functions such as managing users (e.g., individual band members), groups of users (e.g., marching bands), and creating shows that utilize the lighting units 108. For example, the management console 104 may enable creating, storing, and updating of profiles corresponding to each member of a performance group including information such as instrument and role (e.g., first trumpet, second trumpet, bass drum, clarinet, etc.) and unique identifiers that may be used to identify positions and movement patterns of each member during a performance.

The mobile device 106 may communicatively couple to respective lighting units 108 to enable various control functions of the lighting units 108. The mobile device 106 may execute a mobile application that includes various modes associated with different types of lighting operations. When a user switches between modes, a control signal may be communicated to the lighting unit 108 to enable operation in the selected mode. Furthermore, various control settings configured via the mobile device 106 in association with the different modes may be communicated to the lighting unit 108.

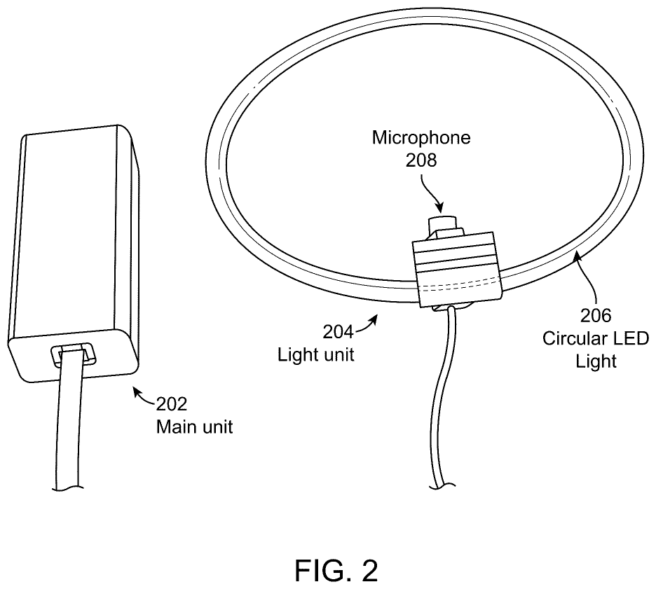

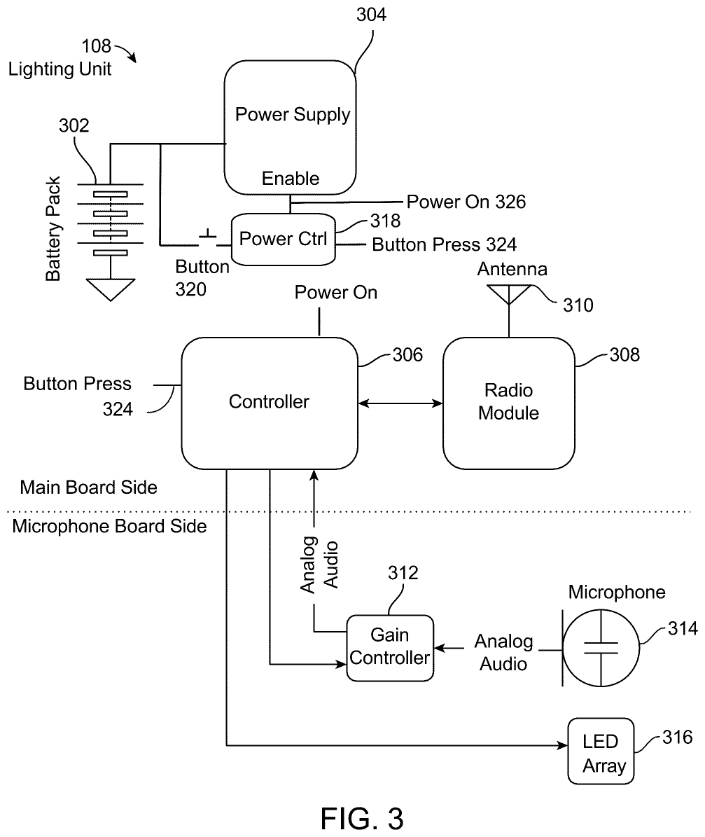

The lighting unit 108 may output various light color and patterns based on detected sound and/or control information from the mobile device 106. The lighting unit 108 may store information about a performance for one specific performer and may be controlled to advance between sets in response to a cue received via radio. In some embodiments, the cue signals may be received via a different communication interface than the configuration settings configured via the mobile device 106. For example, cue signals may be received via a radio broadcast while configuration settings may be downloaded via a direct Bluetooth or other wireless link. The lighting unit 108 may furthermore include a microphone and processing elements to enable pitch recognition and facilitate various operations of the note recognition and tuning modes. An example of a lighting unit is described in further detail below with respect to FIGS. 2-3.

The network 110 may provide communication pathways between the application server 102, the management console 104, and the mobile devices 106. The network 110 may include one or more local area networks (LANs) and/or one or more wide area networks (WANs) including the Internet. Connections via the network 110 may involve one or more wireless communication technologies such as satellite, WiFi, Bluetooth, or cellular connections, and/or one or more wired communication technologies such as Ethernet, universal serial bus (USB), etc.

Functions of the application server 102, management console 104, mobile device 106, and/04 lighting unit 108 may be implemented using one or more computer-readable storage mediums that store instructions executable by one or more processors to carry out the functions described herein.

FIG. 2 illustrates an example embodiment of a lighting unit 108. The lighting unit 108 may include a main unit 202 and a light unit 204. The main unit 202 may comprise a housing containing various electronics for controlling the lighting unit 204 and communicating with the mobile device 106. The light unit 204 may include an LED attachment 206 and a microphone 208. The LED attachment 206 may have various factors to enable attachment to different types of musical instruments or to a performer. For example, in the illustrated example, the LED attachment 206 comprises an LED ring that may be attached to around the perimeter of the bell end of a horn instrument. In other examples, the LED attachment may comprise a bendable LED string that can be formed into any desired shape and attached to an instrument at a desired attachment point. In other embodiments, the LED attachment 206 may comprise a disc-shape or a three-dimensional structure. The LED attachment 206 may attach to the instrument or to a performer via one or more clips, one or more adhesives, one or more straps, one or more ties, one or more magnets, or any other securing mechanism. The attachment 206 may comprise multi-color LEDs to enable lighting in different colors and/or different brightness levels. The on/off setting, color setting, and brightness levels may be controlled by the main unit 202 to change dynamically according to various patterns as will be described further herein.

The light unit 204 may include an LED attachment 206. The LED attachment 206 may comprise a flexible lighting source and may include a single LED or an array of LEDs. In one implementation, the LED attachment 206 could be formed in a circular configuration. The LED attachment 206 may output various light colors and patterns based on control signals from components in the main unit 202.

The microphone 208 captures ambient audio and sends an ambient audio signal to the main unit 202. In the illustrated example, the microphone 208 is attached to the LED attachment 206 (e.g., via a clip or other securing mechanism). Alternatively, the microphone 208 may be attached to the main unit 202 or may be separately attached to a musical instrument or performer.

The main unit 202 and light unit 204 may be directly communicatively coupled via a wired connection such as Ethernet or another suitable wired protocol. In other cases, the main unit 202 and light unit 204 may communicate wirelessly.

FIG. 3 illustrates a block diagram of the lighting unit 108. The lighting unit 108 may include a battery pack 302, a power supply 304, a controller 306, a radio module 308, an antenna 310, a gain controller 312, a microphone 314, an LED array 316, a power control circuit 318, and a button 320. Alternative embodiments may include additional or different components.

The battery pack 302 provides power to the lighting unit 108. In some cases, the battery pack 302 may be rechargeable. Alternatively, the battery pack 302 may include replaceable batteries that are not necessarily rechargeable. The power supply 304 may be connected to the battery pack 302 through the power control circuit 318. The power supply 304 regulates and distributes power to other components of the lighting unit 108.

The power control circuit 318 may control the connection between the battery pack 302 and the power supply 304, allowing a user to turn the lighting unit 108 on or off. In one implementation, the power control circuit 318 operates to toggle the power supply 304 on or off in response to a press of the button 320 (e.g., by switching a power on signal 326 that enables the power supply 304). In one implementation, the power on signal 326 may be toggled when the button press meets certain predefined criteria, such as being held for a certain length of time or being pressed in a defined pattern (e.g., double press or triple press). The power control circuit 318 may also output a button press signal 324 upon detecting a press of the button 320, which may be used by other components of the lighting unit 108 as described below.

The controller 306 may comprise a microcontroller, a general-purpose processor, an application-specific integrated circuit (ASIC), a field-programmable gate array (FPGA), or other controller for controlling functions of the lighting unit 108. The controller 306 may be operatively coupled to the LED array 316, the microphone 314 (via the gain controller 312), and other components of the lighting unit 108. The controller 306 may execute firmware or software instructions to process inputs, manage system states, and control outputs. The controller 306 may also manage internal storage, potentially storing configuration settings, performance data, or firmware updates received through the radio module 308. This may allow the lighting unit 108 to retain settings and performance information even when powered off, enabling quick startup and consistent operation across multiple uses.

The controller 306 may control a mode of the lighting unit 108 in response to the button press signal 324 when the controller is powered on. The button 320 may allow a user to switch between different operating modes of the lighting unit 108 as further described below. For example, when the button press signal 324 may cause the controller 306 to switch between a sequence of modes. The controller 306 may respond differently depending on characteristics of the button press signal 324 such as how long the button 320 was held down and/or whether the button 320 was pressed according to a predefined pattern (e.g., double press or triple press). The controller 306 may also respond differently to button presses 324 depending on the current mode of operation. The controller 306 may update its internal state and reconfigure other components based on the selected mode.

The radio module 308 is coupled to the controller 306 and includes the antenna 310 for enabling wireless communication with the mobile device 106. The radio module 308 may support various wireless protocols such as Bluetooth, Wi-Fi, or cellular connectivity. Alternatively, the radio module 308 and antenna 310 may be omitted and replaced with a wired control interface. In further embodiments, the lighting unit 108 may include both a radio module 308 and a separate wired interface.

The microphone 314 captures ambient audio to generate analog audio signals. The gain controller 312 applies a gain to the captured audio signal to adjust its amplitude before sending the signals to the controller 306.

The LED array 316 outputs light based on control signals from the controller 306. In some cases, the LED array 316 may be capable of producing multiple colors and brightness levels.

In some cases, the lighting unit 108 may be divided into a main board side and a microphone board side. The main board side may include components such as the controller 306 and the radio module 308, while the microphone board side may include the microphone 314 and the gain controller 312. This division may correspond to the separation between the main unit 202 and the light unit 204 shown in FIG. 2.

In operation, the controller 306 may control lighting of the LED array 316 either directly or in a sound-responsive manner based on the audio signal received from the microphone 314. For example, when operating in a tone-responsive mode, the controller 306 may process audio signals from the microphone 314 to detect musical tones, determine a lighting setting based on the detected tones, and control the LED array 316 according to the lighting setting. In performance modes, the controller 306 may control lighting of the LED array 316 according to a preprogrammed lighting pattern. The lighting pattern may be selected from a set of predefined patterns based on a cuing signal received via the radio module 308. For example, in the context of a marching band performance, the controller 306 may receive the cuing signal to indicate when to transition between predefined sets and control the LED array 316 according to the preprogrammed lighting pattern associated with that set.

In an alternative embodiment, the lighting unit 108 may include two or more buttons to control different functionalities. For example, in one implementation, a dedicated power button controls a switch between the battery pack 302 and the power supply 304 to control turning on and off the lighting unit 108, while a separate mode control button supplies the button press signal 324 to the controller 306 for mode control. In further embodiments, the lighting unit 108 may have three or more buttons including multiple buttons dedicated to different control functions or sets of control functions.

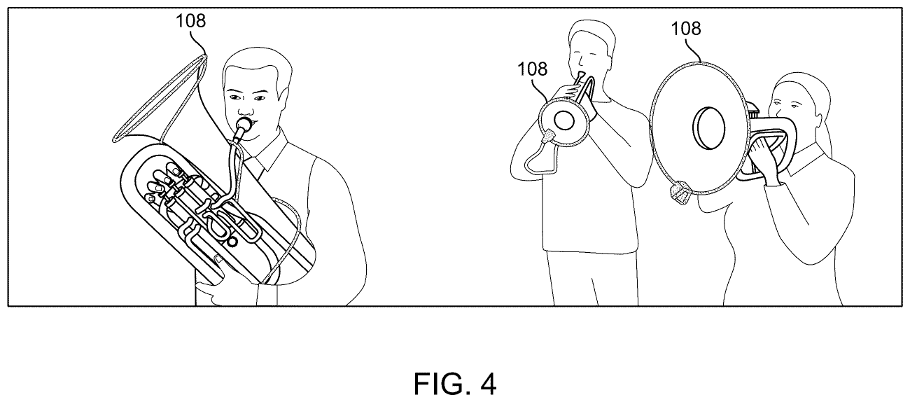

FIG. 4 illustrates various examples of lighting units 108 attached to different musical instruments. The lighting units 108 may be designed to accommodate attachment to a variety of instrument types and configurations. For example, as illustrated in FIG. 4, a ring-shaped lighting unit 108 may be attached around a perimeter of a horn end of brass instruments. In further embodiments, the lighting unit 108 may be attached to the performer instead of the instrument.

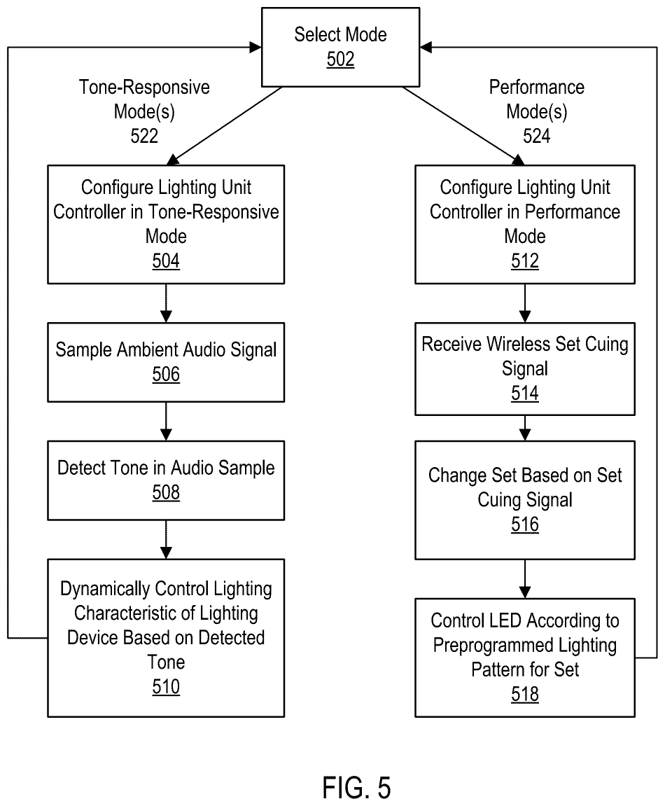

FIG. 5 illustrates a flowchart for operating a lighting unit 108 in different modes. The lighting unit 108 is selectable 502 between a plurality of different modes including one or more tone-responsive modes 522 (e.g., a tone color mode, a tuning mode, a gaming mode, etc.) and one or more performance modes 524. If one of the tone-responsive modes is selected, the process configures 504 the lighting unit 108 to operate in the tone-responsive mode. The controller 306 samples 506 an ambient audio signal via the microphone 314. The controller 306 then detects 508 a tone in the audio sample. Depending on the selected mode, the detected tone may be quantized to the nearest musical tone (e.g., when operating in the tone color mode or gaming mode), or the detected tone may include tones in between musical tones (e.g., when operating in a tuning mode that indicates how many cents flat or sharp the detected tone is). The controller 306 dynamically controls 510 the lighting characteristic of the LED array 316 based on the detected tone. For example, in a tuning mode, the controller 306 may control a color, light intensity, on/off pattern, or other lighting characteristics that indicate whether the detected tone is flat, sharp, or in-tune relative to a musical tone. In a tone color mode, the controller 306 may control a color, light intensity, on/off pattern, or other lighting characteristics indicative of the nearest musical tone. In a gaming mode, the controller may control a color, light intensity, on/off pattern, or other lighting characteristics indicative of accuracy of the tone relative to a predefined musical score.

If a performance mode is selected, the lighting unit 108 is configured 512 to operate in the performance mode. The lighting unit 108 receives a wireless set cuing signal via the radio module 308 that indicates a current set to be performed. The controller 306 changes 516 between sets based on the set cuing signal. Here, each set may correspond to a performance component during which the lighting unit 108 operates according to a predefined lighting pattern. For example, in a marching band performance, each set may correspond to a specific song, portion thereof, or set of songs in the performance. Sets may also be coordinated with specific formations created by the performers in synchronization with the musical performance. For each set, the controller 306 controls 518 the LED array 316 according to the preprogrammed lighting pattern for the set.

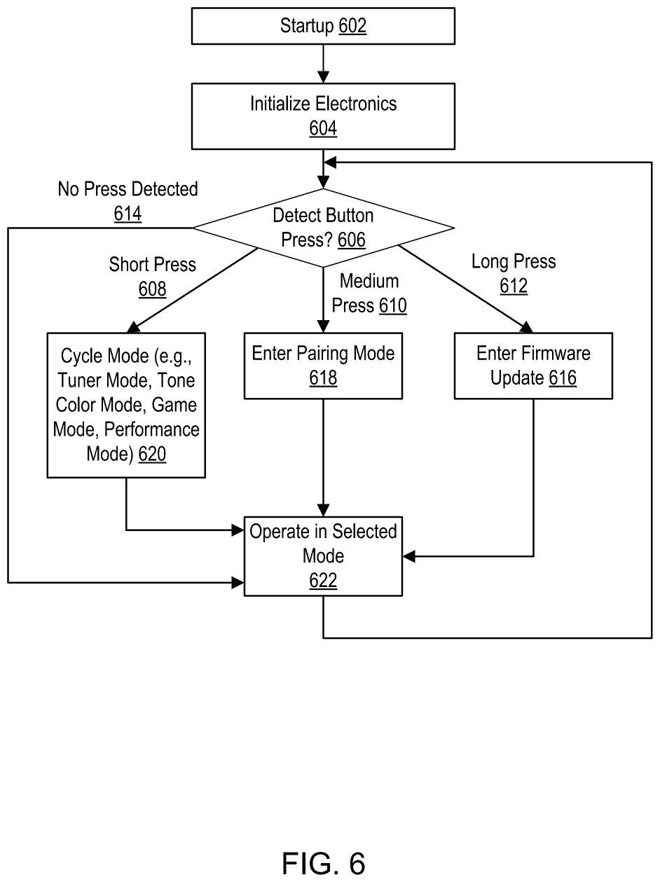

FIG. 6 illustrates a flowchart illustrating a control scheme for the lighting unit 108 that enables control over various functions described herein using a single button 520. At startup 602, the lighting unit 108 initializes 604 electronics of the lighting unit 108 (e.g., Bluetooth and/or other radio functionality of the radio module 308, non-volatile memory, radio, or other components). The lighting unit then checks 606 for a button press of the mode button 320. Here, the lighting unit 108 may determine whether a short press 608 (e.g., less than 2 seconds), a medium press 610 (e.g., between 2 and 6 seconds), or a long press 612 (e.g., greater than 6 seconds) is detected. If a long press 612 is detected, the lighting unit 108 may enter 616 a firmware update mode to initiates a firmware update. Here, the lighting unit 108 may connect to a paired mobile device 106, check whether a firmware update is available, and receive and install the update if available. If a medium press 610 is detected, the lighting unit 108 may enter 618 a pairing mode to initiate a pairing with the mobile device 106 (e.g., via Bluetooth or other connectivity protocol). If a short press 608 is detected, the lighting unit 108 may cycle 620 between a predefined sequence of operating modes (e.g., a tuner mode, a tone color mode, a game mode, a performance mode, or other modes). For example, each short button press 608 may switch to the next mode in the sequence. The lighting unit 108 then operates 622 in the selected mode corresponding to the detected button press. Depending on the mode, operation may involve communicating with the mobile device 106 (e.g., to receive firmware updates, to perform pairing, or to listen for cuing signals) and/or controlling the LED 112. If no button press is detected 614, the lighting unit 108 continues to operate 622 in the currently selected mode. The process may repeat in a loop as long as the lighting unit 108 remains powered on.

FIG. 6 illustrates just one example control scheme. Other control schemes may map interactions with the mode button 320 to different modes according to a different mapping. In other embodiments, the lighting unit 108 may be controlled using other types of control elements such as two or more input buttons mapped to different functions, dials or other control mechanisms, voice control mechanisms, gesture control mechanism, or remote control inputs. In further embodiments, control of the lighting unit 108 may be enabled via the user interfaces of the mobile device 106.

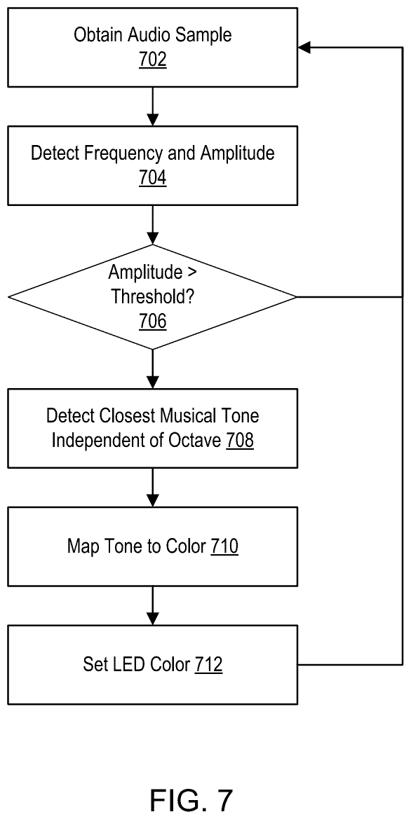

FIG. 7 illustrates an example embodiment of a process performed by the lighting unit 108 when operating in a tone color mode. The controller 306 obtains 702 an audio sample by sampling ambient via the microphone 314. Sampling may occur at a predefined periodic sampling rate. The controller 306 determines 704 a frequency and amplitude of the sampled audio. The controller 306 may then compare 706 the amplitude to a minimum threshold. If the amplitude is not sufficiently large (i.e., the amplitude is not over the minimum threshold amplitude), the lighting unit 108 may ignore the sample and continue to the next sample. If the amplitude exceeds the minimum threshold, the controller 306 detects 708 the closest musical tone independent of the octave. For example, in one implementation, the controller 306 calculates a base 2 logarithm of the frequency and discards the integer part of the logarithm, leaving only the fractional part. The controller 306 then rounds the fractional part to the closest tone on the musical scale. The controller 306 maps 710 the detected tone to a color based on predefined mapping. The mapping may be programmed into the lighting unit 108, for example, via the mobile device 106. The controller 306 may control the LED array 316 to set 712 the configured color. This color output may therefore provide visual feedback indicative of the detected musical tone.

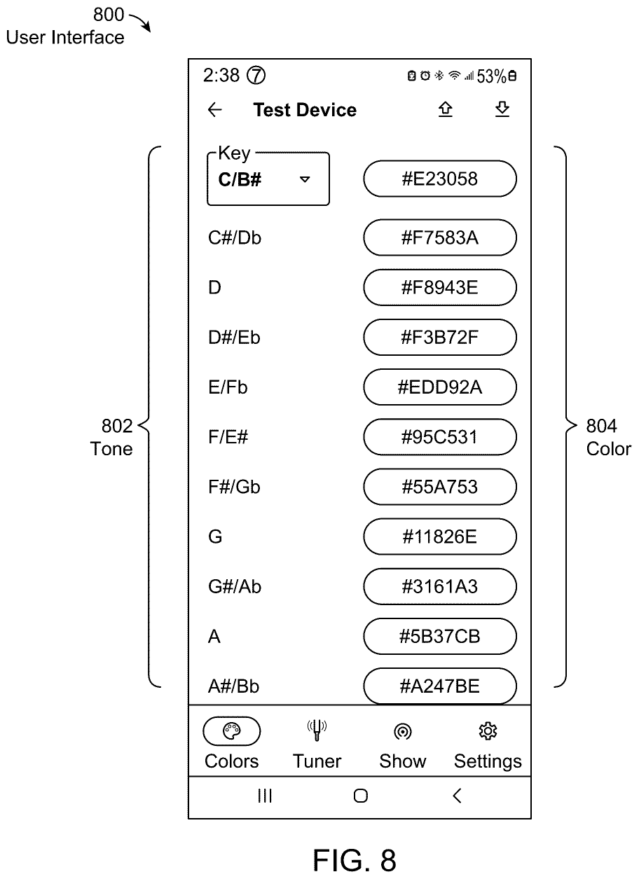

FIG. 8 illustrates a configuration screen 800 of a mobile device 106 for configuring settings associated with a tone color mode of a lighting unit 108. The configuration screen 800 may include a musical note list 802 and a color selector 804. The musical note list 802 may display the chromatic scale of musical notes. In some cases, the musical note list 802 may include notes from C/B through A/Bb. The musical note list 802 may enable a user to view and select specific musical notes for color assignment. Adjacent to each note in the musical note list 802, the configuration screen 800 may include a color selector 804. The color selector 804 may display the currently assigned color for each corresponding musical note. In some cases, the color selector 804 may represent each color using a corresponding hexadecimal color code. The configuration screen 800 may enable users to associate specific colors with different musical notes for the lighting unit's 108 note recognition functionality. When a user interacts with the color selector 804, the mobile device 106 may present additional interface elements for choosing or inputting a desired color for the selected note. In some cases, the configuration screen 800 may include options for reverting to default colors or applying custom-defined colors for each note. Once configured, the settings from the configuration screen 800 may be communicated to the lighting unit 108 via the mobile device 106. The controller 306 of the lighting unit 108 may then use these settings to control the LED array 316 based on detected musical tones during operation in the note recognition mode.

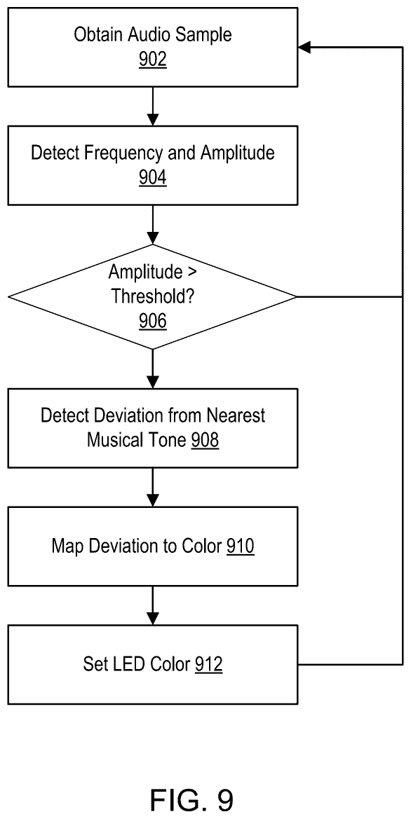

FIG. 9 illustrates an example embodiment of a process performed by the lighting unit 108 when operating in the tuning mode. In the tuning mode, the controller 306 may compare a detected pitch from the ambient audio signal against a reference pitch, and control the LED to output a color indicative of whether the detected pitch is sharp, flat, or in tune relative to the reference pitch. The controller 306 may receive, via the communication interface, user-defined color settings associating specific colors with sharp, flat, and in-tune pitch states, and control the LED according to these user-defined color settings. In one implementation of the tuning mode, the lighting unit 108 obtains 902 an audio sample via the microphone and detects 904 the frequency and amplitude of the sample. If the amplitude is not sufficiently large (e.g., over a minimum threshold amplitude) 906, the lighting unit 108 ignores the sample and proceeds to the next sample. Otherwise, the controller 306 detects 908 a deviation of the frequency from the nearest musical tone on the musical scale. In one implementation, the controller 306 detects a reference pitch representing the closest musical tone by taking the base 2 log of the frequency and discarding the integer portion (ignoring the octave). The detected pitch is then compared to the reference pitch to detect whether the detected pitch is in tune, flat, or sharp relative to the reference. Here, the controller 306 may determine that the detected pitch is in-tune if it is within a predefined threshold range of reference, and may otherwise determine that the detected pitch is sharp or flat if it is above or below the predefined threshold range respectively. The lighting unit 108 maps 910 the deviation to a color and sets 912 the LEDs accordingly to visually indicate the tuning performance. For example, in one implementation, a different color may be set to indicate flat, sharp, or in-tune. In other embodiments, a fine-grained color mapping may be used to indicate different degrees of flatness or sharpness. Alternatively, color may be used to indicate flat, sharp, or in-tune, while the brightness may be set to indicate the degree of flatness or sharpness.

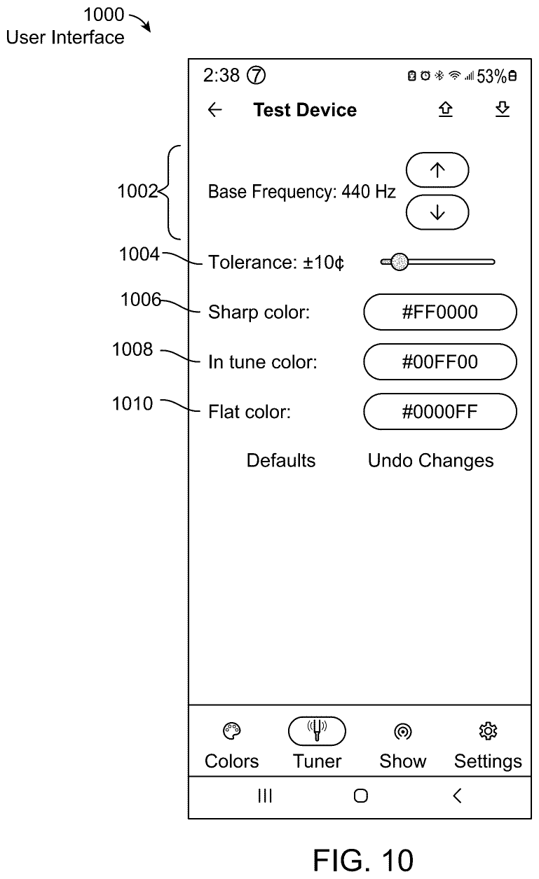

FIG. 10 is an example embodiment of a user interface screen 1000 of the mobile device 106 for configuring settings associated with the tuning mode. Here, the user interface screen may include controls 1002 for setting reference frequencies for different notes, controls 1004 for setting tolerance, and controls 1006, 1008, 1010 for associating specific colors with detecting sharp, in tune, or flat pitches relative to the base frequencies. Colors may be specified by selection from a color chart or by entering a hexadecimal representation of the color.

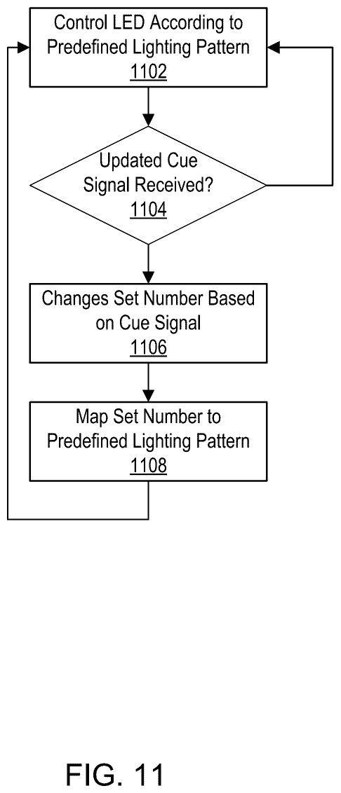

FIG. 11 is an example embodiment of a flowchart associated with operating the lighting unit 108 in a performance mode. The lighting unit 108 controls the LED array 316 to display a predefined lighting pattern associated with the current set. The lighting pattern may comprise a static color and intensity, an on/off pattern, a dynamically changing color and/or brightness pattern, or other predefined pattern of lighting characteristics. The lighting unit 108 determines 1104if an updated cue signal is received 1102 (e.g., as a radio broadcast message from a mobile device 106 or other lighting unit 108) indicative of a change to the current set. If no cue signal is detected, the lighting unit 108 continues to operate according to the current set. If an updated cue signal is detected 1104, the lighting unit 108 changes the set number based on the cuing signal. In one implementation, the set number may be encoded directly in the cue signal. In another implementation, the cuing signal controls the lighting unit 108 to advance to a next set in a preprogrammed set sequence. The lighting unit 108 maps 1108 the set number to a predefined lighting pattern associated with the set and the process repeats.

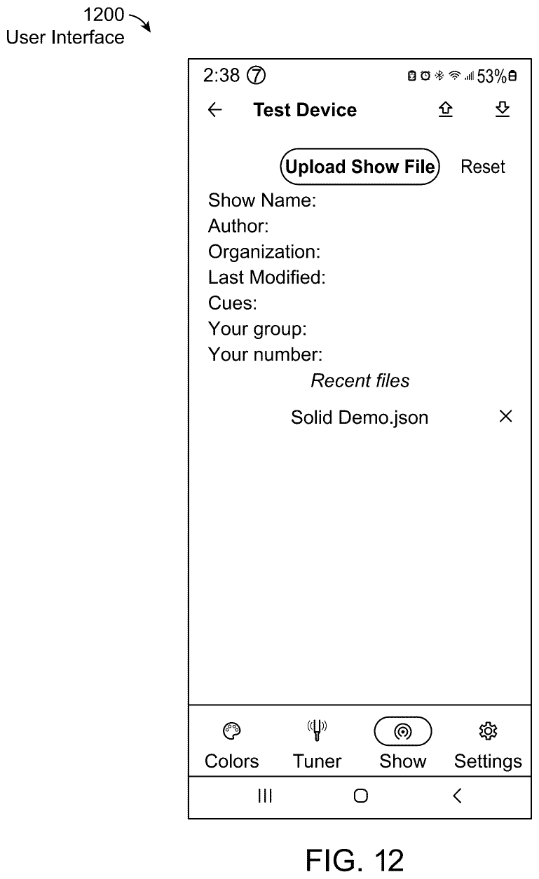

FIG. 12 illustrates an example user interface 1200 for a mobile device 106 associated with loading a performance file. The interface may show various information about the performance, and a control button to upload the show file to the lighting unit 108.

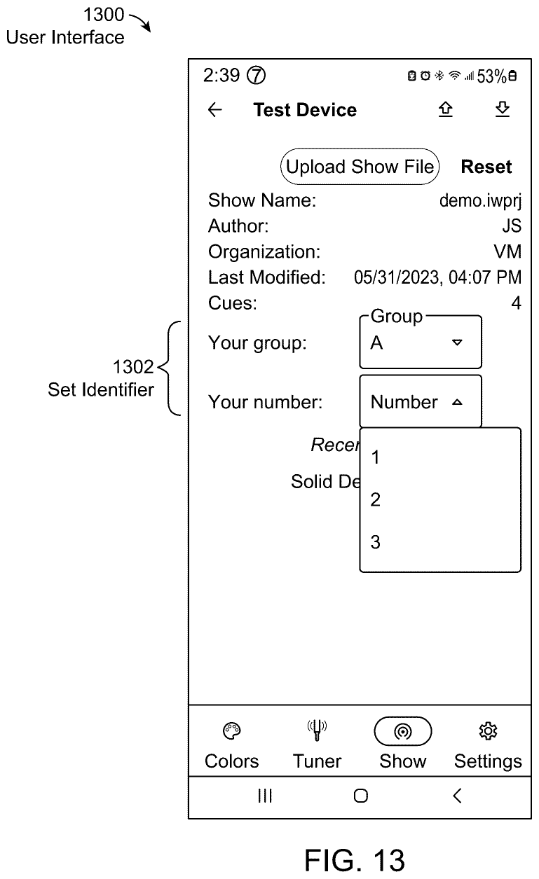

FIG. 13 shows another user interface 1300 associated with the performance mode. This interface allows an identifier 1302 to be selected for a performer in the performance mode. In this example, the identifier 1302 includes a group identifier (e.g., identified by a letter) and an individual identifier (identified by a number). The combination of group identifier and individual identifier represents a unique performer identifier associated with an individual performer taking part in the performance.

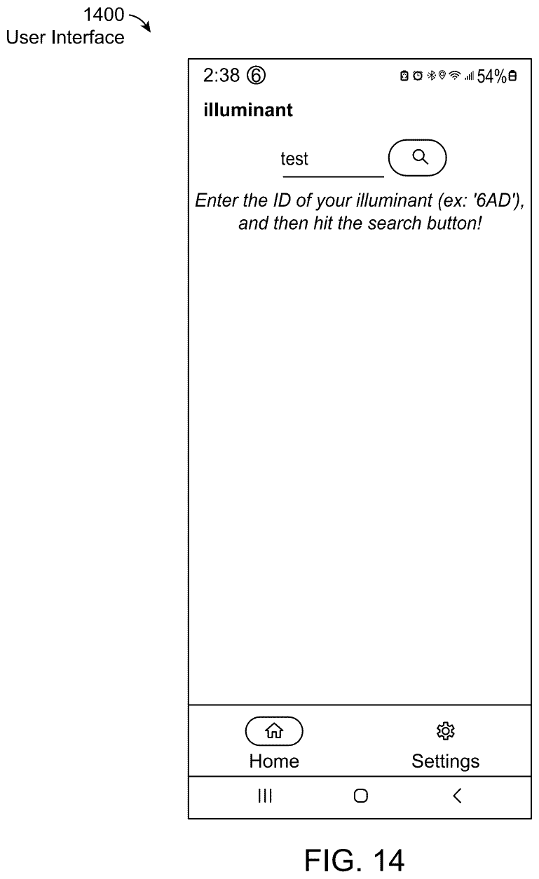

FIG. 14 is a first screen 1400 that is displayed upon opening the application on the mobile device 106, and enabling the user to initiate a connection to a lighting unit 108 (e.g., by entering an identifier associated with the lighting unit 108).

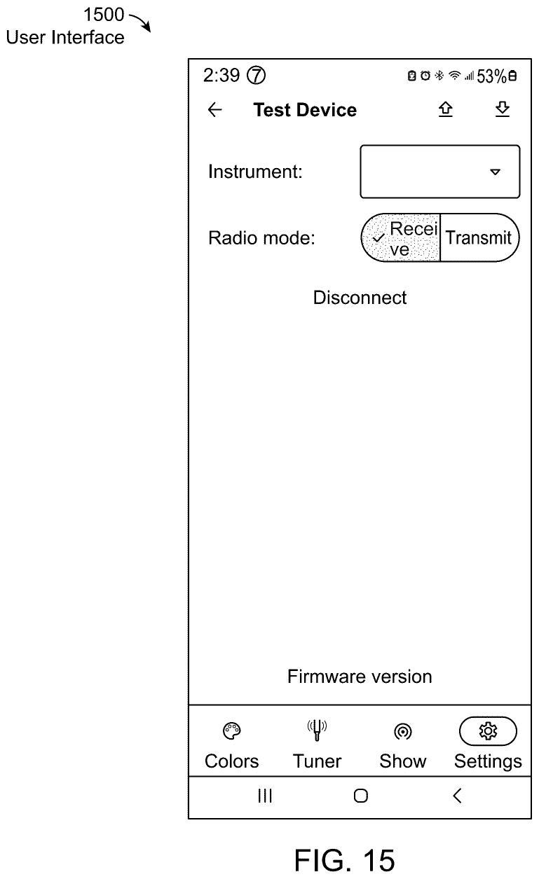

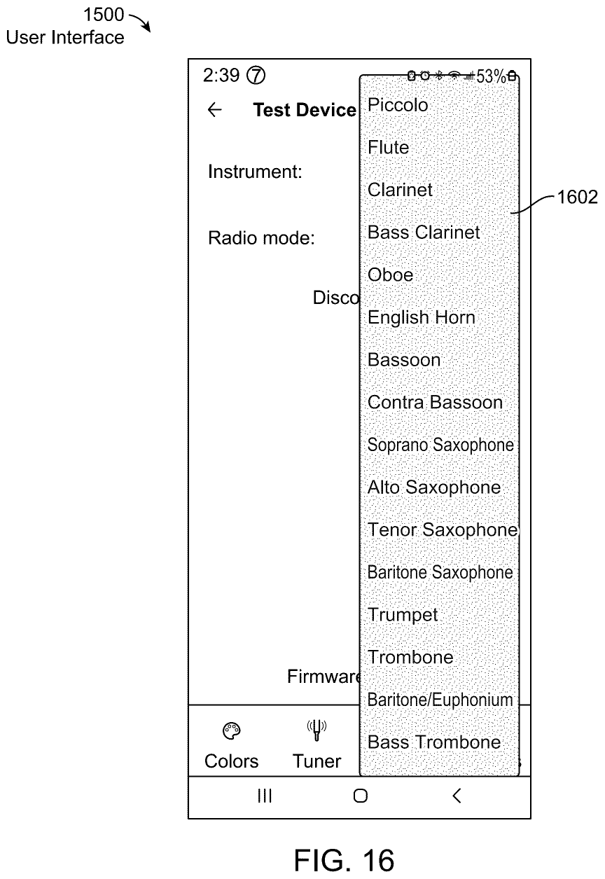

FIGS. 15-16 illustrate an example settings page 1500 that enables selection of instrument to be associated with the mobile application and the connected lighting unit 108. The instrument may be selected from a predefined list 1602 (as shown in FIG. 16) in one embodiment.

In another embodiment, the tone-responsive mode may include a game mode. When operating in the game mode, the controller 306 may compare detected musical tones from the ambient audio signal to a predefined musical score and control the LED to output lighting patterns indicative of accuracy of the detected musical tones relative to the predefined musical score. Here, the color output may be indicative of whether the tone matches or does not match the expected tone from the music score (e.g., green to indicate correct notes and red to indicate incorrect notes).

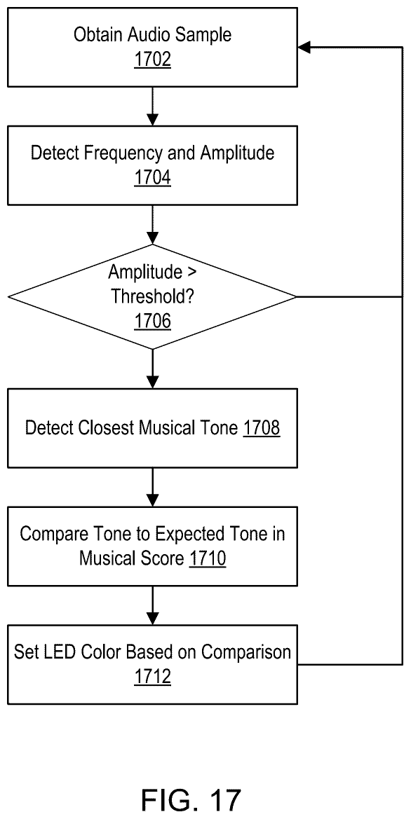

FIG. 17 illustrates an example embodiment of a process performed by the lighting unit 108 when operating in a gaming mode. The controller 306 obtains 1702 an audio sample by sampling ambient via the microphone 314. Sampling may occur at a predefined periodic sampling rate. The controller 306 determines 1704 a frequency and amplitude of the sampled audio. The controller 306 may then compare 1706 the amplitude to a minimum threshold. If the amplitude is not sufficiently large (i.e., the amplitude is not over the minimum threshold amplitude), the lighting unit 108 may ignore the sample and continue to the next sample. If the amplitude exceeds the minimum threshold, the controller 306 detects 1708 the closest musical tone. The controller 306 compares 1710 the detected tone to an expected tone in a musical score. The controller 306 may control the LED array 316 to set 1712 the configured tone dependent on the comparison. For example, the controller 306 may apply a first color to indicate a correct note and a second color to indicate an incorrect note. In an embodiment, the comparison may be made in time-synchronized manner such that the expected note in the musical score updates over time in accordance with the expected timing in the musical score. Alternatively, the expected note in the musical score may advance only when the correct note is detected regardless of timing (e.g., to enable a performer to practice at slow tempos).

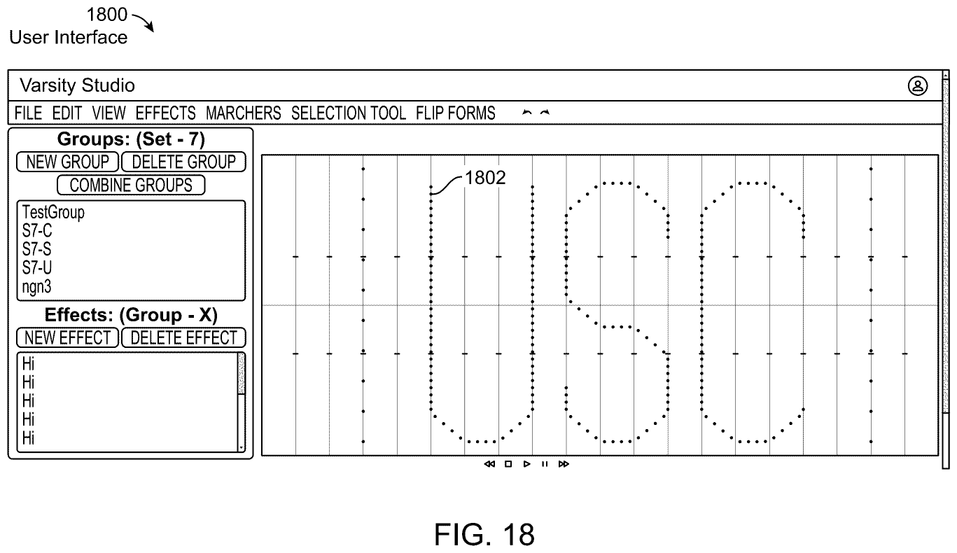

FIG. 18 is an example embodiment of a user interface 1800 of a management application that may be executed on the management console 104 (either directly via an installed application or via a web browser accessing a management application executing on the application server 102). This user interface 1800 allows an administrator to create sets for the performance mode. Here, each performer is represented by a unique identifier which may be organized into groups. The groups may correspond to individual instrument groups (e.g., trumpet, trombone, etc.), instrument sub-groups (e.g., first trumpet, second trumpet, etc.), instrument sections (e.g., horns, woodwinds, percussion, etc.), or any other arbitrary grouping of performers. An ordered sequence of sets may be created, where each set may specify positions of each of the performers within a field formation, which may change between sets. The user interface 1800 furthermore allows creation of preprogrammed lighting configurations that may be assigned to each group or individual identifier per set. The lighting configurations may specify a lighting color pattern, lighting intensity pattern, on/off pattern, or other lighting configuration for the set. In this manner, lighting patterns may be coordinated between the performers in a set and may relate to the formation and/or musical score being performed. Once the sets are created, a set of configuration files may be generated for each identifier. Each file may include the preprogrammed lighting patterns associated with the identifier and the mapping between set identifiers and the lighting patterns. The files may be downloaded to individual lighting units 108 to enable each lighting unit 108 to obtain its individualized lighting configurations such that the set of lighting units 108 can operate in coordination during a performance.

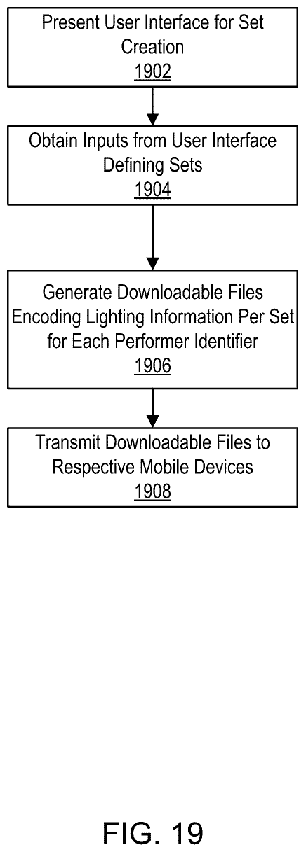

FIG. 19 is a flowchart illustrating an example embodiment of a process performed by the management application. The management application presents 1902 a user interface for enabling user creation of the predefined group of sets. The management application obtains 1904, via the user interface, a set of inputs defining each of the predefined group of sets. The sets may be associated with respective set identifiers uniquely identifying each set. Using the user interface, the creator may generate a field formation associated with the set (such as shown in FIG. 18). The formation may be defined by respective positions for each performer (identified by respective performers) that collectively result in a desired shape or pattern. Creating the set may also include assigning respective lighting patterns to the performer identifiers (e.g., color, brightness, on/off pattern, dynamically changing lighting pattern, etc.). The lighting patterns are not necessarily uniform and different performers may be assigned different lighting characteristics within the set. The set may also be linked to a specific portion of a musical score. The management application may furthermore define transitions between sets (e.g., the path and timing of each performer's movement from the position within one set to the next). The management application may enable the creator to easily visualize sequences of sets in a static or animated manner, create new sets, and/or update existing sets.

When a set creation is completed, the management application may generate 1906 respective downloadable files for each of the set of performer identifiers. The downloadable files identify, for a particular performer identifier, the respective lighting patterns associated with each set identifier. The respective downloadable files may then be transmitted to respective mobile devices 106 associated with the respective performer identifiers (which may subsequently synch them to the connected lighting units 108).

In one implementation, the downloadable files include only the respective lighting information for a single performer identifier. Alternatively, the downloadable files may include a universal information set that includes the lighting information linked to respective performer identifiers for all performers (or a subset of performers). In this implementation, the mobile device 106 may identify and apply the lighting pattern matched to its performer identifier.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A lighting device for a musical instrument, comprising:
an LED configured to attach to a musical instrument;
a microphone;
a communication interface configured to communicate with a mobile device; and
a controller operatively coupled to the LED, the microphone, and the communication interface, wherein the controller is selectable between a plurality of operating modes including at least one tone-responsive mode and at least one performance mode,
wherein in the at least one tone-responsive mode, the controller operates to receive an ambient audio signal from the microphone, detect a tone of the musical instrument based on the ambient audio signal, and dynamically control a lighting characteristic output by the LED based on the detected tone,
wherein in the at least one performance mode, the controller operates to wirelessly receive a set cuing signal from the communication interface for changing between a predefined group of sets, and to control the LED during each of the sets according to respective preprogrammed lighting patterns for each of the sets.

2. The lighting device of claim 1, wherein the at least one tone-responsive mode includes a tuning mode, wherein when operating in the tuning mode, the controller is configured to compare a detected pitch from the ambient audio signal against a reference pitch, and to control the LED to output a color indicative of whether the detected pitch is sharp, flat, or in tune relative to the reference pitch.

3. The lighting device of claim 2, wherein the controller is configured to receive, via the communication interface, user-defined color settings associating specific colors with sharp, flat, and in-tune pitch states, and wherein the controller controls the LED according to the user-defined color settings.

4. The lighting device of claim 1, wherein the at least one tone-responsive mode includes a tuning mode, and wherein when operating in the tuning mode, the controller is operable to perform steps including:
sampling audio via the microphone to obtain sampled audio;
determining a frequency and amplitude of the sampled audio;
comparing the amplitude to a minimum threshold; and
if the amplitude exceeds the minimum threshold, detecting a closest musical note to the frequency, determining a deviation between the frequency and the musical note, mapping the deviation to an LED color based on a predefined mapping, and setting the LED to output the LED color.

5. The lighting device of claim 1, wherein the at least one tone-responsive mode includes a game mode, wherein when operating in the game mode, the controller is configured to compare detected musical tones from the ambient audio signal to a predefined musical score and to control the LED to output lighting patterns indicative of accuracy of the detected musical tones relative to the predefined musical score.

6. The lighting device of claim 1, wherein the at least one tone-responsive mode includes a tone color mode, wherein when operating in the tone color mode, the controller is configured to detect a pitch from the ambient audio signal and control the LED to output a color mapped to the pitch based on a predefined tone color mapping.

7. The lighting device of claim 6, wherein the controller is configurable to receive, via the communication interface, the predefined tone color mapping from a user interface of a mobile device that obtains user-defined color mappings.

8. The lighting device of claim 1, wherein the at least one tone-responsive mode includes a tone color mode, wherein when operating in the tone color mode, the controller is operable to perform steps including:
sampling audio via the microphone to obtain sampled audio;
determining a frequency and an amplitude of the sampled audio;
comparing the amplitude to a predefined minimum threshold; and
if the amplitude exceeds the predefined minimum threshold, determining a closest musical note to the frequency, mapping the closest musical note to a mapped color based on a predefined mapping, and setting the LED to output the mapped color.

9. The lighting device of claim 1, wherein the set cuing signal specifies a set number from the predefined group of sets.

10. A method of operating a lighting device attachable to a musical instrument, the method comprising:
configuring a controller of the lighting device in a tone-responsive mode;
while operating in the tone-responsive mode:
sampling an ambient audio signal received from a microphone of the lighting device to obtain an audio sample;
detecting a tone of the audio sample; and
dynamically controlling a lighting characteristic of an LED of the lighting device based on the detected tone;
reconfiguring the controller of the lighting device to operate in performance mode;
while operating in the performance mode:
receiving, by a communication interface of the lighting device, a wireless set cuing signal; and
changing, by the controller, between a predefined group of sets based on the received set cuing signal and controlling, by the controller, the LED during each of the predefined group of sets according to respective preprogrammed lighting patterns for each of the predefined group of sets.

11. The method of claim 10, wherein the tone-responsive mode includes a tuning mode, and wherein dynamically controlling the lighting characteristic of the LED of the lighting device based on the detected tone comprises:
comparing a detected pitch from the ambient audio signal against a reference pitch; and
controlling the LED to output a color indicative of whether the detected pitch is sharp, flat, or in tune relative to the reference pitch.

12. The method of claim 11, further comprising:
receiving, via the communication interface, user-defined color mapping associating specific colors with sharp, flat, and in-tune pitch states; and
wherein controlling the LED to output the color comprises applying the user-defined color mapping.

13. The method of claim 10, wherein the tone-responsive mode includes a tuning mode, and wherein dynamically controlling the lighting characteristic of the LED of the lighting device based on the detected tone comprises:
sampling audio via the microphone to obtain sampled audio;
determining a frequency and amplitude of the sampled audio;
comparing the amplitude to a minimum threshold; and
if the amplitude exceeds the minimum threshold, detecting a closest musical note to the frequency, determining a deviation between the frequency and the musical note, mapping the deviation to an LED color based on a predefined mapping, and setting the LED to output the LED color.

14. The method of claim 10, wherein the tone-responsive mode includes a game mode, and wherein dynamically controlling the lighting characteristic of the LED of the lighting device based on the detected tone comprises:
comparing detected musical tones from the ambient audio signal to a predefined musical score; and
controlling the LED to output lighting patterns indicative of accuracy of the detected musical tones relative to the predefined musical score.

15. The method of claim 10, wherein the tone-responsive mode includes a tone color mode, and wherein dynamically controlling the lighting characteristic of the LED of the lighting device based on the detected tone comprises:
detecting a pitch from the ambient audio signal; and
controlling the LED to output a color mapped to the pitch based on a predefined tone color mapping.

16. The method of claim 15, further comprising:
receiving, via the communication interface, the predefined tone color mapping from a user interface of a mobile device that obtains user-defined color mappings.

17. The method of claim 10, wherein the tone-responsive mode includes a tone color mode, and wherein dynamically controlling the lighting characteristic of the LED of the lighting device based on the detected tone comprises:
sampling audio via the microphone to obtain sampled audio;
determining a frequency and an amplitude of the sampled audio;
comparing the amplitude to a predefined minimum threshold; and
if the amplitude exceeds the predefined minimum threshold, determining a closest musical note to the frequency, mapping the closest musical note to a mapped color based on a predefined mapping, and setting the LED to output the mapped color.

18. A system comprising:
a lighting device for a musical instrument, the lighting device comprising:
an LED;
a microphone;
a communication interface configured to communicate with a mobile device; and
a controller operatively coupled to the LED, the microphone, and the communication interface, wherein the controller is selectable between a plurality of operating modes including at least one tone-responsive mode and at least one performance mode,
wherein in the at least one tone-responsive mode, the controller operates to receive an ambient audio signal from the microphone, detect a tone of the musical instrument based on the ambient audio signal, and dynamically control a lighting characteristic output by the LED based on the detected tone,
wherein in the at least one performance mode, the controller operates to wirelessly receive a set cuing signal from the communication interface for changing between a predefined group of sets, and to control the LED during each of the sets according to respective preprogrammed lighting patterns for each of the sets;
a non-transitory computer-readable storage medium of the mobile device storing instructions that, when executed by a processor of the mobile device, cause the mobile device to perform steps including:
establish a wireless connection with the lighting device via the communication interface;
transmitting control information to the lighting device including at least one color mapping applied by the lighting device in the tone-responsive mode that maps the detected tone to the lighting characteristic; and
transmitting set information to the lighting device including the predefined group of sets for the at least one performance mode.

19. The system of claim 18, wherein the at least one tone-responsive mode includes a tuning mode, wherein when operating in the tuning mode, the controller is configured to compare a detected pitch from the ambient audio signal against a reference pitch, and to control the LED to output a color indicative of whether the detected pitch is sharp, flat, or in tune relative to the reference pitch.

20. The system of claim 18, further comprising:
a non-transitory computer-readable storage medium storing instructions executable by a one or more processors for implementation of a management application, the instructions when executed by the one or more processors performing steps including:
presenting, via the management application, a user interface for enabling user creation of the predefined group of sets;
obtaining, via the user interface, a set of inputs defining each of the predefined group of sets, wherein the sets are characterized by respective set identifiers, a field formation including respective positions for each of a set of performer identifiers, respective lighting patterns associated with each of the set of performer identifiers, and a portion of a musical score associated with the set identifier;
generating, by the management application, respective downloadable files for each of the set of performer identifiers, the respective downloadable files identifying the respective lighting patterns associated with corresponding set identifiers; and
transmitting the respective downloadable files to respective mobile devices associated with the respective performer identifiers.
